(19) United States
(12) Patent Application Publication
(10) Pub. No.: US 2024/0211034 A1
(43) Pub. Date: Jun. 27, 2024

(54) METHODS AND SYSTEMS FOR GAZE ASSISTED INTERACTION

(71) Applicants: Juntao YE, Markham (CA); Manpreet Singh TAKKAR, Markham (CA); Soumil CHUGH, Markham (CA)

(72) Inventors: Juntao YE, Markham (CA); Manpreet Singh TAKKAR, Markham (CA); Soumil CHUGH, Markham (CA)

(21) Appl. No.: 18/146,183

(22) Filed: Dec. 23, 2022

(51) Int. Cl. G06F 3/01

(52) U.S. Cl. CPC G06F 3/013

(57) ABSTRACT

Methods and systems for gaze assisted interaction with a pointing device on a display screen. In response to receiving an activation input, a user's point of gaze (POG) on a display is received and a gaze region of the display corresponding to the POG is extracted, enlarged and transposed on the display according to a first cursor location, generating an interaction region on the display. A user interaction with the pointing device at a second cursor location on the display associated with the interaction region is intercepted in a system hook, mapped to a location on the display corresponding to the gaze region and passed to an application. The disclosed method and system may enable improved GUI interaction with pointing devices on displays while overcoming challenges associated with the precision of eye-gaze assisted interaction, including the impact of eye jittering on gaze estimation.

### FIELD

The present disclosure relates to the field of human-computer interaction, in particular methods and systems for gaze assisted interaction.

### BACKGROUND

Human-computer interaction explores how people interact with computers and computing devices. A device that enables interaction between a person and a computing device is known as a human-computer interface. Pointing devices are commonly used human-computer interface devices that allow a user to input spatial (i.e., continuous and multi-dimensional) data to a computer, for example, by controlling a cursor on a display screen. As modern software and graphical user interfaces (GUI) become more complex, for example, by incorporating an increasing variety of user-interface (UI) widgets, the management of display screen real-estate for efficient human-computer interaction becomes more challenging.

For commonly used pointing devices (e.g. computer mouse, touch pad, touch screen, stylus, joystick etc.) the motor input required to perform an interaction is proportional to the distance to be covered by the cursor on the screen. Over time, the physical size, resolution and pixel density of display screens have increased while the size of content on screen, for example, text and icons, has become smaller. Moreover, multiple screen configurations utilizing extended displays are becoming increasingly common. Accordingly, manipulation of cursors or pointers across larger display screen distances may be difficult, often requiring multiple swipes on a touch pad or requiring a user to lift and re-position a mouse on a mouse pad between movements. In other environments, for example, in a vehicle including one or more display screens, it may be difficult for an operator to safely reach out to interact with a screen. Furthermore, the reduction in relative sizes of text or icons on screen contributes to challenges with interaction precision and accuracy, for example, in situations where pixel-level localization is needed. Challenges arise, for example, when a fast gross movement is performed by a user to quickly manipulate a cursor of a pointing device over a large screen distance, followed by a slower fine movement to precisely interact with a small content item or object. In this regard, it may be difficult for users to execute interactions that are both quick and precise.

Gaze assisted interaction adds an input from a user's eye gaze information to at least one other input mode, (for example, a pointing device, a keyboard, a gesture recognition system etc.) for interacting with a computing system. For example, to assist in the control of a GUI element such as a cursor on a display screen, or in viewing content items on screen, for example, by magnifying elements on screen, among others.

For example, U.S. Pat. No. 6,204,828, the entirety of which is hereby incorporated by reference, discloses an interaction scenario incorporating gaze tracking, where upon receipt of a mechanical input (e.g. a mouse click), a cursor is repositioned on a screen to correspond with a gaze region on a screen. However, bringing a cursor to an area of the screen where a user is gazing does not address the difficulties with precise control of small GUI elements.

In another example, U.S. Pat. No. 10,444,831, the entirety of which is hereby incorporated by reference, discloses a system incorporating gaze and head tracking for hands-free device control, for example, using head gestures for mode switching or cursor control. However, a disadvantage to this approach includes that the use of head tracking introduces jitter into the pointer control. Furthermore, performance may be negatively affected in poor lighting conditions.

In another example, an approach for content magnification based on gaze when interacting with virtual environments is discussed in: Agledahl, S., & Steed, A., “Magnification Vision—a Novel Gaze-Directed User Interface” 2021 IEEE Conference on Virtual Reality and 3D User Interfaces Abstracts and Workshops (VRW), IEEE, 2021, the entirety of which is hereby incorporated by reference. However, the described approach is limited to virtual environments and may not generalize well in real-world environments using common computing devices such as laptops, desktops or tablets without the inclusion of specific hardware. Furthermore, the approach does not address the need for rapid interaction across large distances.

In another example, an approach for text magnification is discussed in: Aguilar, C. & Castet, E., “Evaluation of a gaze-controlled vision enhancement system for reading in visually impaired people” PLOS One 12.4 (2017): e0174910, the entirety of which is hereby incorporated by reference. However, the described approach is limited to a specific application where a user is reading content on screen, and not generalized for other GUI element interaction scenarios.

One drawback of current approaches to gaze assisted interaction is a failure to account for the small, rapid eye movements known as jitter. While the human eye has the benefit of moving at very high speed, during this movement a user's gaze direction constantly changes, even during gaze fixation, making it difficult to precisely control pointing devices with gaze tracking.

Accordingly, it would be useful to provide methods and systems to improve user interaction with a pointing device on a display screen.

### SUMMARY

In various examples, the present disclosure describes methods and systems for improved user interaction with a pointing device on a display screen, for example, using multiple input modes. Specifically, user interaction with a pointing device on a display screen may be assisted by input from eye gaze information. In response to receiving an activation input, a user's point of gaze (POG) on a display is received. A gaze region corresponding to the user's point of gaze is extracted, enlarged and transposed on the display according to a first cursor location on the display, thereby generating an interaction region. A user interaction with the pointing device at a second cursor location on the display screen associated with the interaction region is intercepted in a system hook, mapped to a location on the display corresponding to the gaze region and passed to an application. The disclosed method and system may enable improved GUI interaction in real-life environments (e.g. using multiple extended screens, or under a range of illumination conditions that may impact gaze tracking accuracy) while overcoming challenges associated with the precision of eye-gaze assisted interaction with a pointing device on a display screen, for example, the impacts of eye jittering on gaze estimation.

In various examples, the present disclosure provides the technical effect that executing an operation with a pointing device on a computing system incorporates input from an additional source, namely, eye gaze information. In this regard, gaze assisted interaction aims to improve user interaction with a GUI on a display screen by addressing existing challenges with the use of pointing devices and display screens.

In examples, instead of moving the pointing device to manipulate a cursor to a desired display content, a user may gaze at a desired display content and activate a delimiter operation to initiate a gaze assist operation. In some examples, the present disclosure provides the technical advantage that spatial movements and interactions with pointing devices to manipulate pointers (for example, cursors) in a GUI may be performed both quickly and with high precision. For example, in a situation where a user is required to move a pointing device quickly over a large distance, for example, to move a cursor to a screen destination that is far from the cursor origin, and then slow down the movement to manipulate a pointing device with high precision while interacting with GUI elements (e.g. icons, buttons, text) at the screen destination. In this regard, transitioning from gross to fine movement with high speed and precision may be useful in time sensitive or real-time scenarios, for example, while operating a machine or a vehicle, or while interacting with video games, among others.

In some examples, the present disclosure provides the technical advantage that the speed of eye gaze movement may be leveraged to perform long distance pointer movement or other manual operations typically performed with a pointing device, with greater speed and efficiency. Furthermore, using eye gaze to assist with gross movement rather than precise interaction with GUI objects may reduce challenges associated with eye jittering or gaze estimation accuracy.

In some examples, the present disclosure provides the technical advantage that operator fatigue associated with gross motor movements of a pointer device (e.g. to manipulate a cursor over a large screen distance) is reduced. For example, gaze assisted interaction may overcome the need for gross or repetitive motor movements of the pointing device to manipulate a pointer across large display screen distances, for example, in interactions that require actions in distant regions of the screen.

In some examples, the present disclosure provides the technical advantage that input precision with the pointing device is improved by magnifying on-screen content prior to initiating an input operation with the pointing device. In this regard, interaction with on-screen content may be easier and errors caused by a user selecting incorrect objects, for example, due to difficulties with fine motor manipulation of the pointing device or an inability to read small content on-screen, among others, may be reduced.

In some aspects, the present disclosure describes a method for eye-gaze assisted interaction with a pointing device on a display screen. The method comprises a number of steps. The method comprises: receiving an activation input for initiating a gaze assist operation corresponding to an application; in response to receiving the activation input, receiving a point of gaze for a user on a display; further in response to receiving the activation input, receiving a first cursor location for a pointing device on the display; extracting a gaze region based on the point of gaze on the display; generating an interaction region based on the gaze region and the first cursor location; receiving an interaction event corresponding to the interaction region at a second cursor location for the pointing device on the display; and in a system hook, generating a replacement interaction event for passing to the application, the replacement interaction event being generated in response to receiving the interaction event at the second cursor location.

In the preceding example aspect of the method, wherein generating a replacement interaction event comprises: receiving an interaction mapping for relating a position of the gaze region on the display to a position of the interaction region on the display; mapping the second cursor location to a replacement cursor location based on the interaction mapping; and generating the replacement interaction event based on the replacement cursor location.

In the preceding example aspect of the method, the method further comprises: processing the replacement interaction event to execute a command operation of the application.

In an example aspect of the method, wherein extracting the gaze region comprises: generating an image of a portion of the content of the display based on the point of gaze.

In the preceding example aspect of the method, wherein generating an interaction region comprises: magnifying the image of the portion of the content of the display to generate a magnified image; and generating the interaction region based on the magnified image and the first cursor location.

In an example aspect of the method, wherein a size of the image of the portion of the content of the display depends on a degree of accuracy of the point of gaze.

In an example aspect of the method, wherein receiving the activation input comprises: receiving a delimiter operation input including at least one of: a pointing device input; a keyboard event input; a gesture input; or an audio input.

In an example aspect of the method, wherein receiving the activation input comprises: receiving a delimiter operation input including: a point of gaze at a first location on the display; and a mouse event at a second location on the display; wherein a distance between the first and second locations on the display exceeds a threshold value.

In an example aspect of the method, wherein obtaining a point of gaze for a user on the display comprises: obtaining a face image for the user; computing eye gaze information based on the face image; and computing the point of gaze on the display based on the eye gaze information.

In an example aspect of the method, the method further comprises: receiving a request to terminate the gaze assist operation.

In some aspects, the present disclosure describes a system comprising: a pointing device; a display; one or more processor devices; and one or more memories storing machine-executable instructions, which when executed by the one or more processor devices, cause the system to: receive an activation input for initiating a gaze assist operation corresponding to an application; in response to receiving the activation input, receive a point of gaze for a user on the display; further in response to receiving the activation input, receive a first cursor location for the pointing device on the display; extract a gaze region based on the point of gaze on the display; generate an interaction region based on the gaze region and the first cursor location; receive an interaction event corresponding to the interaction region at a second cursor location for the pointing device on the display; and in a system hook, generate a replacement interaction event for passing to the application, the replacement interaction event being generated in response to receiving the interaction event at the second cursor location.

In the preceding example aspect of the system, wherein the machine-executable instructions, when executed by the one or more processors cause the system to generate a replacement interaction event by: receiving an interaction mapping for relating a position of the gaze region on the display to a position of the interaction region on the display; mapping the second cursor location to a replacement cursor location based on the interaction mapping; and generating the replacement interaction event based on the replacement cursor location.

In the preceding example aspect of the system, wherein the machine-executable instructions, when executed by the one or more processors further cause the system to: process the replacement interaction event to execute a command operation of the application.

In an example aspect of the system, wherein the machine-executable instructions, when executed by the one or more processors cause the system to extract the gaze region by: generating an image of a portion of the content of the display based on the point of gaze.

In the preceding example aspect of the system, wherein the machine-executable instructions, when executed by the one or more processors cause the system to generate an interaction region by: magnifying the image of the portion of the content of the display to generate a magnified image; and generating the interaction region based on the magnified image and the first cursor location.

In an example aspect of the system, wherein a size of the image of the portion of the content of the display depends on a degree of accuracy of the point of gaze.

In an example aspect of the system, wherein the machine-executable instructions, when executed by the one or more processors cause the system to receive the activation input by: receiving a delimiter operation input including at least one of: a pointing device input; a keyboard event input; a gesture input; or an audio input.

In an example aspect of the system, wherein the machine-executable instructions, when executed by the one or more processors cause the system to receive the activation input by: receiving a delimiter operation input including: a point of gaze at a first location on the display; and a mouse event at a second location on the display; wherein a distance between the first and second locations on the display exceeds a threshold value.

In an example aspect of the system, wherein the machine-executable instructions, when executed by the one or more processors cause the system to obtain a point of gaze for a user on the display by: obtaining a face image for the user; computing eye gaze information based on the face image; and computing the point of gaze on the display based on the eye gaze information.

In some example aspects, the present disclosure describes a computer readable medium storing instructions thereon. The instructions, when executed by one or more processors unit of a computing system, cause the computing system to: receive an activation input for initiating a gaze assist operation corresponding to an application; in response to receiving the activation input, receive a point of gaze for a user on the display; further in response to receiving the activation input, receive a first cursor location for the pointing device on the display; extract a gaze region based on the point of gaze on the display; generate an interaction region based on the gaze region and the first cursor location; receive an interaction event corresponding to the interaction region at a second cursor location for the pointing device on the display; and in a system hook, generate a replacement interaction event for passing to the application, the replacement interaction event being generated in response to receiving the interaction event at the second cursor location.

### BRIEF DESCRIPTION OF THE DRAWINGS

Reference will now be made, by way of example, to the accompanying drawings which show example embodiments of the present application, and in which:

FIG. 1 is a block diagram illustrating an example computing system which may be used to implement examples of the present disclosure;

FIG. 2 is a schematic representation of a graphical user interface (GUI) presented on a display of the computing system of FIG. 1, suitable for implementation of examples described herein;

FIG. 3 is a block diagram illustrating an example architecture of a gaze assisted interaction system, in accordance with examples of the present disclosure;

FIG. 4 is a schematic representation of a GUI presented on a display of the computing system of FIG. 1, in accordance with an example embodiment;

FIG. 5 is a block diagram illustrating an example architecture of an interception module, in accordance with examples of the present disclosure; and

FIG. 6 is a flowchart illustrating an example method for gaze assisted interaction on a display screen, in accordance with examples of the present disclosure;

Similar reference numerals may have been used in different figures to denote similar components.

### DETAILED DESCRIPTION

The following describes example technical solutions of this disclosure with reference to accompanying drawings.

To assist in understanding the present disclosure, the following describes some relevant terminology that may be related to examples disclosed herein.

In the present disclosure, a “pointing device” can mean: a human-computer interface device that enables a user to input spatial data to a computer. In examples, a pointing device may be a handheld input device, including a mouse, a touch pad, a touch screen, a stylus, a joystick, or a trackball, among others. In examples, a pointing device may be used to control a cursor or a pointer in a GUI for pointing, moving or selecting text or objects on a display screen, among others. In examples, spatial data may be continuous and/or multi-dimensional data.

In the present disclosure, “display contents” or “contents of the display” can mean: an image that is displayed on a display screen of a computing system, for example, showing a desktop or an active application window or any number of application windows that may be positioned to be simultaneously visible on the display screen.

In the present disclosure, “gaze tracking” or “gaze estimation” can mean: a method of tracking eye movements and estimating either a gaze vector (e.g., an estimated gaze vector may contain two angles describing the gaze direction, the angles being a yaw and a pitch) or a point of gaze (POG) either on a display screen or in a surrounding environment. A common approach for gaze estimation is video-based eye tracking, for example, using a camera to capture face or eye images and computing a gaze vector or a POG from the face or eye images.

In the present disclosure, “point of gaze (POG)” can mean: the object or location within a scene of interest where an individual is looking, or more specifically, the intersection of a gaze vector with a scene of interest. In some examples, a POG may correspond to a location on a display screen where a visual axis intersects the 2D display screen. In examples, a POG on a display screen may be described by a set of 2D coordinates (x,y) corresponding to a position on the display screen, relative to a display screen coordinate system.

In the present disclosure, “eye gaze information” may include information representing a user's gaze direction, for example, a gaze vector or a point-of-gaze (POG) on a display screen or in a surrounding environment, among others.

In the present disclosure, “fixation state” can mean: a state in which a user is maintaining gaze on a single location. While a user is in a fixation state, the user's eyes do not remain entirely still and they may exhibit jitter. In the present disclosure, “jitter” or “jittering” can mean: small involuntary movements made by the eye during fixation. In examples, jitter may not noticeably impact a user's vision, however jitter can pose challenges for gaze tracking systems.

In the present disclosure, a “saccade” can mean: a quick, simultaneous movement of both eyes between two or more fixation states, for the purpose of orientating a point of gaze from one location to another. Saccades are voluntary and not to be mistaken for jitter.

In the present disclosure, a “delimiter operation” can mean: an indication within a stream of data, text or expressions that marks a boundary between two distinct regions in the stream of data, text or expressions. In the present disclosure, a delimiter operation may be generated in response to an action performed by a user in order to invoke or activate the gaze assisted interaction system functionality, for example, using a device input (e.g., a mouse click, a keyboard, a voice command, a mid-air gesture or body movement, etc.) or a combination of device inputs, or using other delimiter operation logic.

In the present disclosure, a “gaze region” or a “gaze region of interest (ROI)” can mean: a region of a display screen that encompasses a user's point of gaze, for example, with rectangular dimensions characterized by a width (w) and a height (h) and a center point corresponding to the user's POG (x,y).

In the present disclosure, an “enlarged gaze region” or “enlarged region of interest (eROI)” can mean: an image serving as a magnified or enlarged copy of the ROI encompassing the user's POG, for example, with rectangular dimensions characterized by a width (s) and a height (t) and a center point corresponding to a cursor position (a,b).

In the present disclosure, an “interaction region” can mean:

In the present disclosure, a “cursor” can mean: a moveable object used to indicate a position on a display screen. In examples, a cursor may be a pointer associated with a mouse or another pointing device, or a cursor may be any movable indicator on a display screen corresponding to an input device and indicating a position on the display identifying the position where an input operation may be directed. For example, a cursor of a pointing device may indicate a location on the display screen corresponding to an interaction event, for example, a mouse event (e.g., a mouse click, double click, mouse up or mouse down), a touchpad event (e.g., a tap action, or a swipe action), or a keyboard event (e.g., a text cursor may identify where typed text will be inserted or deleted), among others. In the present disclosure, a cursor position on a display screen may be described by coordinates relative to the coordinate system of the display.

In the present disclosure, a “GUI object” or a “GUI element” can mean: an object or element visible within the GUI that is associated with a control operation within an application window, for example, an icon, a button, a folder, a menu etc. that requires user interaction (e.g. mouse click, tap, swipe etc.) to execute an operation.

Other terms used in the present disclosure may be introduced and defined in the following description.

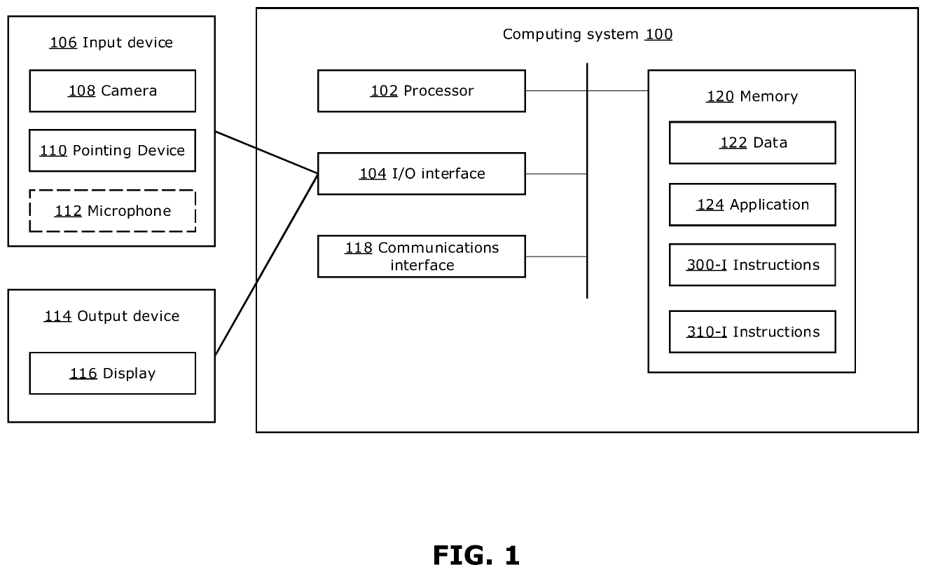

FIG. 1 is a block diagram illustrating a simplified example implementation of a computing system 100 that is suitable for implementing embodiments described herein. Examples of the present disclosure may be implemented in other computing systems, which may include components different from those discussed below. The computing system 100 may be used to execute instructions for gaze assisted pointing device interaction, using any of the examples described herein.

Although FIG. 1 shows a single instance of each component, there may be multiple instances of each component in the computing system 100. Further, although the computing system 100 is illustrated as a single block, the computing system 100 may be a single physical machine or device (e.g., implemented as a single computing device, such as a single workstation, single end user device, single server, etc.), and may include mobile communications devices (smartphones), laptop computers, tablets, desktop computers, vehicle driver assistance systems, smart appliances, wearable devices, assistive technology devices, virtual reality devices, augmented reality devices, Internet of Things (IOT) devices and interactive kiosks, among others.

The computing system 100 includes at least one processor 102, such as a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 may include an input/output (I/O) interface 104, which may enable interfacing with an input device 106 and/or an output device 114. In the example shown, the input device 106 (e.g., a keyboard, a touchscreen, a keypad etc.) may also include a camera 108 (e.g., an RGB camera or an infrared (IR) camera), a pointing device 110 (e.g., a mouse, a stylus, a touchpad, a track ball and/or a joystick) or optionally, a microphone 112. In the example shown, the output device 114 may include a display 116, among other output devices (e.g., a speaker and/or a printer). In other example embodiments, there may not be any input device 106 and output device 114, in which case the I/O interface 104 may not be needed.

The computing system 100 may include an optional communications interface 118 for wired or wireless communication with other computing systems (e.g., other computing systems in a network). The communications interface 118 may include wired links (e.g., Ethernet cable) and/or wireless links (e.g., one or more antennas) for intra-network and/or inter-network communications.

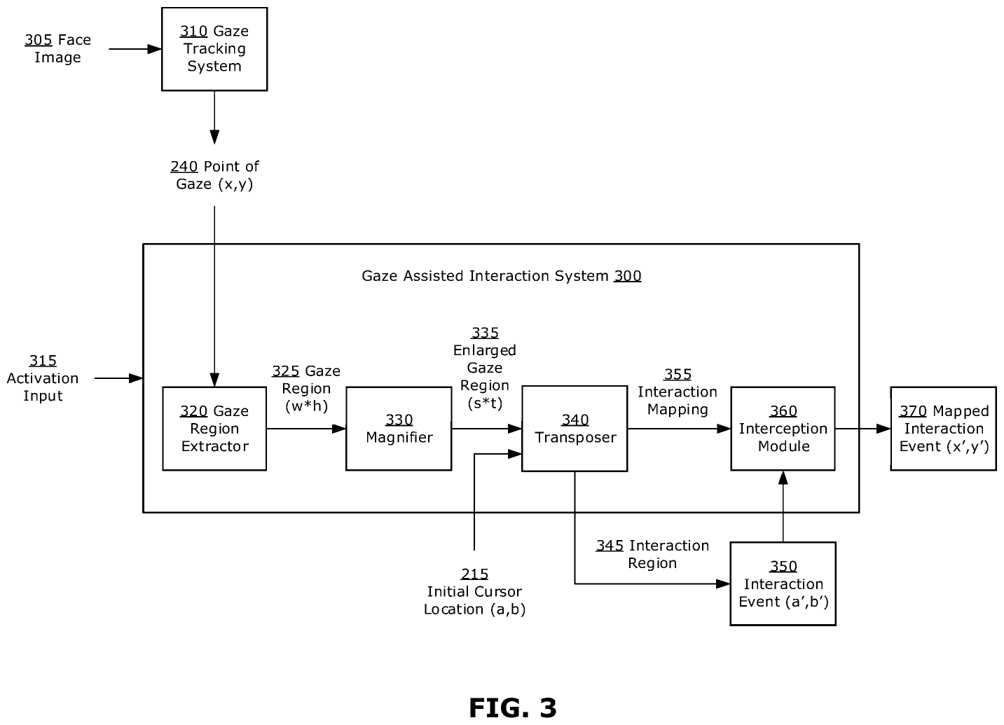

The computing system 100 may include one or more memories 120 (collectively referred to as “memory 120”), which may include a volatile or non-volatile memory (e.g., a flash memory, a random access memory (RAM), and/or a read-only memory (ROM)). The non-transitory memory 120 may store instructions for execution by the processor 102, such as to carry out examples described in the present disclosure. For example, the memory 120 may store instructions for implementing any of the networks and methods disclosed herein. The memory 120 may include other software instructions, such as for implementing an operating system (OS) and other applications 124 or functions. The instructions can include instructions 300-I for implementing and operating the gaze assisted interaction system 300 described below with reference to FIG. 3. The memory 120 may also store other data 122, information, rules, policies, and machine-executable instructions described herein, for example, including instructions 310-I for implementing a gaze tracking system 310.

In some examples, the computing system 100 may also include one or more electronic storage units (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 120 to implement data storage, retrieval, and caching functions of the computing system 100. The components of the computing system 100 may communicate with each other via a bus, for example.

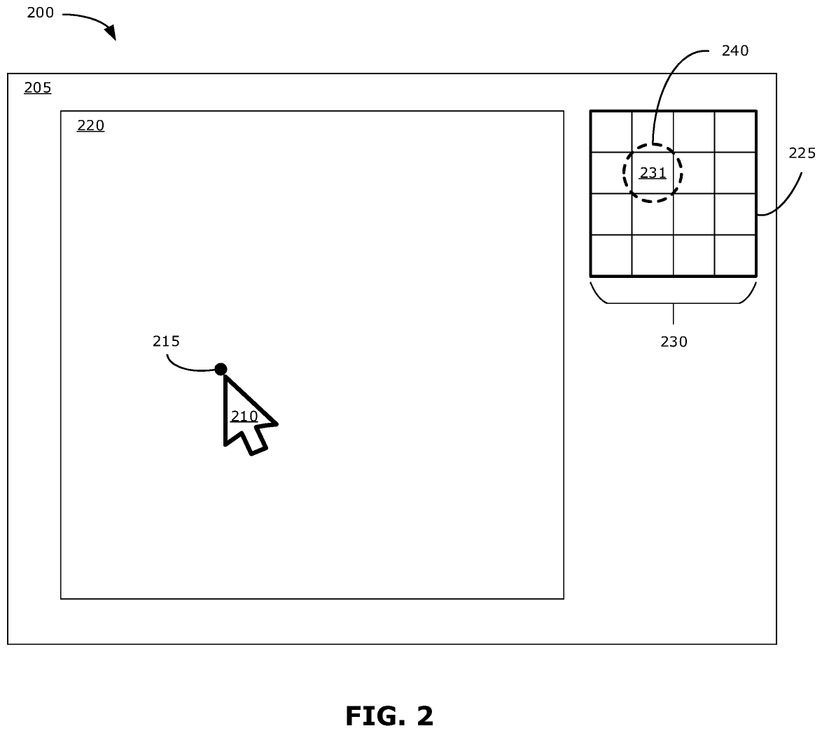

FIG. 2 is a schematic representation of a graphical user interface (GUI) 200 presented on a display 116 of the computing system of FIG. 1, suitable for implementation of examples described herein. The GUI 200 is an illustrative example of an interface to which the systems, methods, and processor-readable media described herein can be applied, in accordance with examples of the present disclosure.

In the illustrated example of FIG. 2, an application window 205 corresponding to a software application 124 is active in the GUI 200 and a cursor 210 is visible within the application window 205. In examples, the cursor 210 may be associated with a pointing device 110 (e.g., a mouse) or the cursor 210 may be a text cursor, among others. In examples, the cursor 210 may be positioned in the application window 205 corresponding to an initial cursor location 215, for example, described by a set of coordinates (a,b) relative to the coordinate space of the display 116. For the purposes of illustration, the application window 205 may represent a drawing application, for example, with a drawing canvas 220 and a control panel 225 including a plurality of GUI objects 230, however it is understood that any application may be used.

Under common use scenarios of an application 124, a user may manipulate a pointing device 110 to move a cursor 210 within an application window 205 in order to engage a desired GUI object 231, for example, by selecting an icon or a button, or interacting with a menu, among others. In examples, prior to moving the cursor 210 to engage with the desired GUI object 231, a user may shift their point of gaze (POG) 240 on the display 116 and may fixate their POG 240 on the desired GUI object 231 before manipulating the pointing device 110 to move the cursor 210 to the desired GUI object 231 and engaging the pointing device 110 to interact with the desired GUI object 231. In examples, the POG 240 of the user may be determined by a gaze tracking system 310 of the computing system 100. In some embodiments, for example, the POG 240 of the user may be described by a set of coordinates (x,y) relative to the coordinate space of the display 116, as described in the discussion of FIG. 3 below. However, as previously noted, in scenarios where a user must quickly manipulate a cursor over an extended screen distance, it may be difficult to efficiently transition from gross movement of a pointing device 110 to precise control of the pointing device 110 to interact with a desired GUI object 231.

FIG. 3 is a block diagram illustrating an example architecture of the gaze assisted interaction system 300 that may be used to implement methods of gaze assisted pointing device interaction, in accordance with examples of the present disclosure.

In some embodiments, for example, a gaze tracking system 310 external to the gaze assisted interaction system 300 may continuously capture images of a user, (e.g., a face image 305) using a camera 108. In examples, the gaze tracking system 310 may generate eye gaze information, for example, by estimating a point of gaze (POG) 240 of a user from the face image 305. In other embodiments, eye gaze information may include a gaze vector and a POG 240 may be estimated based on the gaze vector and a known position of a display 116. In examples, a POG 240 computed by the gaze tracking system 310 may be input to a gaze region extractor 320 of the gaze assisted interaction system 300.

In examples, typical hardware configuration for gaze tracking systems 310 include remote systems and head mounted or wearable systems. In remote gaze tracking systems, hardware components, including the camera 108, are placed far away from the user, whereas in head mounted gaze tracking systems, hardware components are placed inside a head mounted device (e.g., an Augmented Reality (AR) or Virtual Reality (VR) device in the form of a helmet, a headset or a pair of glasses) causing the camera 108 to be positioned in close proximity with the eye. Cameras used in gaze tracking systems may include infrared (IR) cameras (which capture IR data) or RGB cameras (which capture visible spectrum data). In examples, gaze tracking hardware can vary in quality across various devices. For example, remote tracking systems often use an RGB camera that is built into a device (e.g., mobile communications devices, tablets, laptops etc.) whereas external eye-tracking equipment may include IR cameras and may be placed in proximity to the display 116.

In some embodiments, for example, the gaze assisted interaction system 300 may receive other inputs in addition to a POG 240, including an activation signal 315 for initiating a gaze assist operation, an initial cursor location 215 for a cursor visible in an application window 205 on a display 116 prior to initiating a gaze assist operation, and an interaction event 350 executed by a pointing device 110, for example, a mouse event executed by a user during a gaze assist operation. In examples, the gaze assisted interaction system 300 may output a mapped interaction event 370 to an application 124.

In some embodiments, for example, the activation signal 315 is provided to the gaze assisted interaction system 300 to initiate a gaze assist operation. In examples, the activation input 315 may be triggered using an input device, for example, as a delimiter operation. In examples, a delimiter operation may be generated by a voluntary or intentional input action performed by a user to instruct the gaze assisted interaction system 300 to initiate a gaze assist operation. In some embodiments, for example, the input action may be configured so as to be unlikely to be performed accidentally or for a user to accidentally initiate a gaze assist operation. In examples, the delimiter operation may be caused by a device input (e.g., a mouse click, a keyboard, among others), an audio input (e.g., a voice command), a gesture input (e.g., a mid-air gesture or body movement, etc.) or a combination thereof, or using other delimiter operation logic. In some embodiments, for example, the activation signal 315 may be triggered by a keyboard input (e.g., by pressing a particular key on a keyboard), or by a mouse input (e.g., using a programmable key on a mouse), or by a combined mouse-keyboard input. In other embodiments, the activation signal 315 may be triggered by a gesture input performed by a user that is captured by a camera 108 and processed by the gaze tracking system 310, for example, a hand gesture, a facial expression, an eye blink, a head nod, or a combination of gesture inputs. In other embodiments, for example, an activation signal 315 may include a combination of a gaze fixation at a POG 240 and a mouse input at an initial cursor location 215 that is far from the POG 240, for example, greater than a threshold distance from the POG 240.

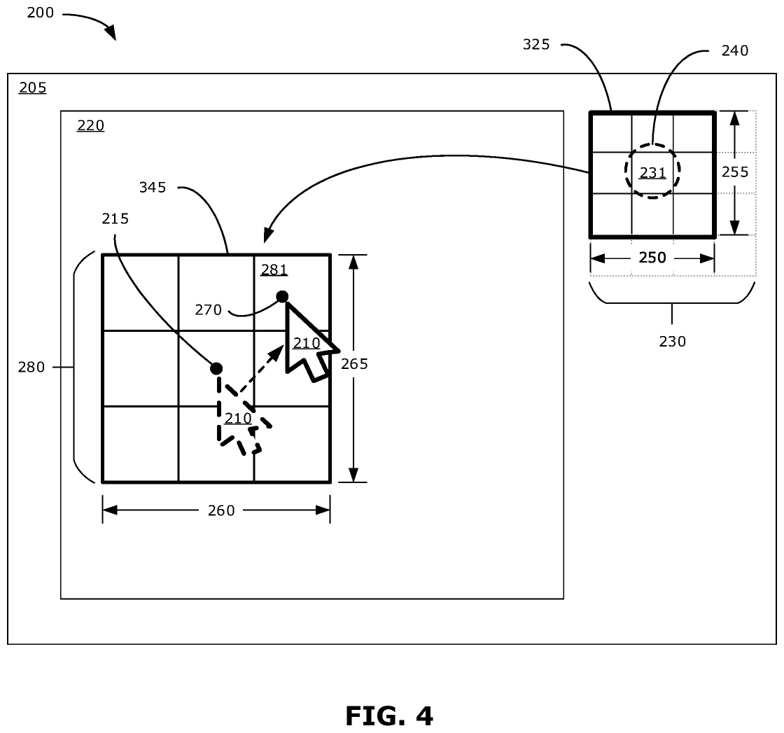

In examples, in response to receiving the activation signal 315, the gaze assisted interaction system 300 may initiate a gaze assist operation. In examples, a gaze assist operation may include receiving an initial cursor location 215 of the pointing device 110, extracting a gaze region 325 of an application window 205 corresponding to a user's point of gaze (POG) 240 and at least one GUI object 230 in the application window 205, magnifying the gaze region 325 to generate an enlarged gaze region 335, transposing the enlarged gaze region 345 to a new location in the application window 205 to generate an interaction region 345, the new location corresponding to the initial cursor location 215, capturing a user interaction event 350 with the pointing device 110 at a second cursor location associated with the interaction region 345 and outputting a mapped interaction event 370 to an application 124, the mapped interaction event 370 corresponding to at least one of the GUI objects 230 in the application window 205. In this regard, the gaze assisted interaction system 300 may address challenges with long-distance cursor movement by benefiting from the quick movement of gaze while avoiding the jittering associated with gaze tracking. For illustrative purposes, an example of a gaze assist operation will be described with reference to FIG. 4 below.

In examples, in response to receiving the activation signal 315, the gaze region extractor 320 of the gaze assisted interaction system 300 may receive the POG 240 and may generate a gaze region 325. In examples, the gaze region 325 may be configured as a single layered window having dimensions (w*h) that captures an image of a portion of the display contents encompassing the POG 240. In examples, the gaze region 325 may overlay the application window 205 or any other open application windows. In examples, the dimensions of the gaze region 325 may be predetermined or the dimensions of the gaze region 325 may depend on the accuracy of the gaze tracking system 310, for example, in response to receiving a POG 240 generated by a gaze tracking system 310 demonstrating lower accuracy (for example, a gaze tracking system 310 using RGB cameras or operating in low lighting conditions), a gaze region extractor 320 may generate a gaze region 325 that is larger than a predetermined size to compensate for error in the POG 240, for example, to ensure that the gaze region 325 adequately captures the portion of the application window 205 corresponding to the user's gaze.

FIG. 4 is a schematic representation of a graphical user interface (GUI) 200 presented on a display 116 of the computing system of FIG. 1, during a gaze assist operation, according to an example embodiment of the present disclosure. The GUI 200 is an illustrative example of an interface to which the systems, methods, and processor-readable media described herein can be applied, in accordance with examples of the present disclosure.

With reference to FIG. 4, the gaze region 325 may be a transparent window having a window image showing a portion of the display contents corresponding to the user's gaze. In examples, the gaze region 325 may be rectangular or square in shape and described by a width w 250 and a height h 255, with the center of the gaze region 325 described by a set of coordinates (x,y) corresponding to the POG 240. In examples, coordinates representing each corner of the gaze region 325 may define the boundary of the window, for example, the top left corner and bottom right corner of the gaze region 325 may be described by:

$$Gaze Region Top Left Corner = ( x - \frac{w}{2} , y - \frac{h}{2} ) \qquad ( 1 a )$$

$$Gaze Region Bottom Right Corner = ( x + \frac{w}{2} , y + \frac{h}{2} ) \qquad ( 1 b )$$

Returning to FIG. 3, the gaze region 325 may be input to a magnifier 330 and the size of the gaze region 325 window and corresponding window image may be enlarged to generate an enlarged gaze region 335 having dimensions (s*t). In examples, the dimensions of the enlarged gaze region 335 may be predetermined or the dimensions of the enlarged gaze region 335 may depend on the size or resolution of the display 116 or the quality of the gaze tracking system 310. In examples, the enlarged gaze region 335 may then be input to a transposer 340 to position the enlarged gaze region 335 on the display 116 based on the initial cursor location 215, generating an interaction region 345. In examples, the interaction region 345 may be a single layered window having a window image representative of a portion of the display contents having dimensions (s*t) and encompassing the POG 240. In examples, the interaction region 345 may overlay the application window 205 or any other open application windows. The transposer 340 may also output an interaction mapping 355 that relates the position of the gaze region 325 to the position of the interaction region 345 on the display 116.

In examples, the dimensions of the interaction region 345 may depend on the quality of the gaze tracking system 310. For example, in response to receiving a POG 240 generated by a gaze tracking system 310 having lower quality hardware or exhibiting noisy or low accuracy performance, the interaction region 345 may include an optional panning operation, to enable a user to manipulate the interaction region 345 (for example, using a specific mouse button that has been configured for executing a panning operation) with a panning motion. In examples, in situations where a gaze tracking system 310 does not accurately capture a desired POG 240 in an interaction region 345, a panning operation may be used to slide the interaction window to bring a desired POG 240 into view.

With reference to FIG. 4, the interaction region 345 may be a transparent window having a window image showing a portion of the display contents corresponding to the user's gaze. In examples, the interaction region 345 may be rectangular or square in shape and described by a width s 260 and a height t 265 with the center of the interaction region 345 described by a set of coordinates (a,b) corresponding to the initial cursor location 215. In examples, coordinates representing each corner of the interaction region 345 may define the boundary of the window, for example, the top left corner and bottom right corner of the interaction region 345 may be described by:

$$Interaction Region Top Left Corner = ( a - \frac{s}{2} , b - \frac{t}{2} ) \qquad ( 2 a )$$

$$Interaction Region Bottom Right Corner = ( a + \frac{s}{2} , b + \frac{t}{2} ) \qquad ( 2 b )$$

In some embodiments, for example, a user may manipulate the pointing device 110 to move the cursor 210 from an initial cursor location 215 on the display 116 to a secondary cursor location 270 on the display 116. In examples, the secondary cursor location 270 may be described by a set of coordinates (a′,b′) relative to the coordinate space of the display 116. In examples, the interaction region 345 may include in its window image, enlarged GUI object images 280 corresponding to the GUI objects 230 of the control panel 225. In examples, when a user manipulates the cursor to a secondary cursor location 270, the secondary cursor location 270 may correspond to a desired one of the GUI object images, for example, desired enlarged GUI object image 281, as illustrated in FIG. 4. Furthermore, a user may interact with the pointing device 110 associated with the cursor 210 to initiate an interaction event 350 at the secondary cursor location 270, for example, by clicking a mouse button or engaging with the pointing device 110 in another way to initiate an interaction event 350.

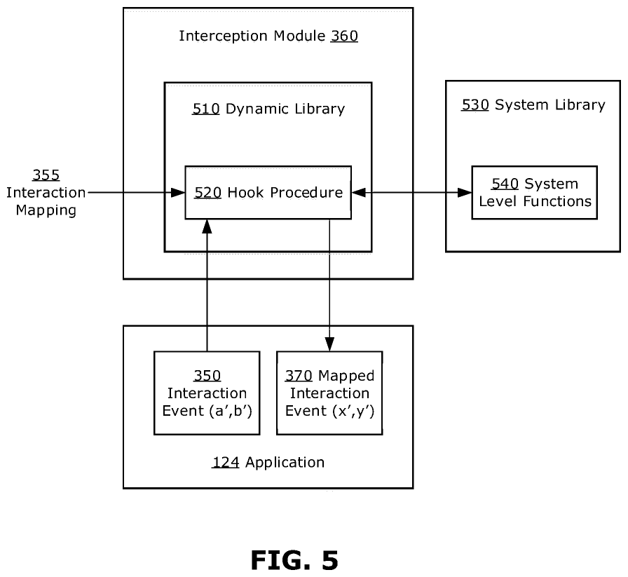

Returning to FIG. 3, an interception module 360 of the gaze assisted interaction system 300 may receive the interaction mapping 355 and the interaction event 350 and may output a mapped interaction event 370, as described in the discussion of FIG. 5 below. In examples, the interception module 360 may be a software that is implemented in the computing system 100, in which the processor 102 is configured to execute instructions 300-I of the gaze assisted interaction system 300 stored in the memory 120.

FIG. 5 is a block diagram illustrating an example interception module architecture 360, that may be used to intercept system level functions 540 called during a gaze assist operation, in accordance with examples of the present disclosure. In some examples, the interception module 360 leverages a hook mechanism for intercepting system level functions 540 called during a gaze assist operation. In the context of intercepting system level functions 540, a hook mechanism may intercept calls between two processes and invoke customized functions in between (e.g., a hook procedure 520).

In examples, during a gaze assist operation, when an interaction event 350 is performed, the interception module 360 may invoke the system library 330 (and the associated system level functions 340) on behalf of the application 124, for example, to generate and pass a replacement event (e.g. a mapped interaction event 370) including a replacement cursor location (x′,y′) back to the application 124. In examples, the coordinates of the replacement cursor location in the mapped interaction event 370 may be computed based on the interaction mapping 355 by:

$${x}^{′} = x + ( {a}^{′} - a ) \times \frac{w}{s} \qquad ( 3 a )$$

$${y}^{′} = y + ( {b}^{′} - b ) \times \frac{h}{t} \qquad ( 3 b )$$

Where (x,y) are coordinates of the POG 240, (a,b) are coordinates of the initial cursor location 215, (a′,b′) are coordinates of the secondary cursor location 270, w is the width of the gaze region 325, h is the height of the gaze region 325, s is the width of the interaction region 345 and h is the height of the interaction region 345. In examples, in response to receiving the mapped interaction event 370, the application 124 may execute a control operation as if the user had performed an interaction event (e.g., a mouse click) directly at the location of the mapped interaction event 370.

Prior to initiating a gaze assist operation, software code may be first initialized to activate the gaze assisted interaction system 300 and load instructions associated with the interception module 360 into a dynamic library 510. In examples, the instructions may include one or more hook procedures 520 to intercept system level functions 540 that are called by an application 124 during a gaze assist operation, for example, a mouse event. For example, in a typical mouse operation within the Windows™ operating system (OS), a mouse event (e.g., a cursor movement, pressing or releasing a mouse button etc.) the OS posts the inputs as messages to the queue of the appropriate thread, where the thread is determined based on the window that the mouse hovers over during the mouse event, or by the window that captured the mouse input. If a hook is used to intercept the mouse event message before it is posted to a queue of a window, the hook procedure may handle the mouse event using its own defined subroutines, before passing the mouse input message onto the next application in the mouse hook chain, or to the target window if the hook chain is empty. While example implementations are described using a mouse as an input device, it is understood that other input devices can be used.

In examples, using system level programming, an option to enable or disable the gaze assisted interaction system 300 may be configured, for example, as a toggle in the system settings for the computing system 100. By implementing the gaze assisted interaction system 300 using system level programming, the interception module 360 may be configured to intercept any interaction event 350 executed with a pointing device 110, corresponding to any program running on top of an OS (e.g., Windows™, Linux™, MacOS™, Android™ etc.) of the computing system 100, while the gaze assisted interaction system 300 is active.

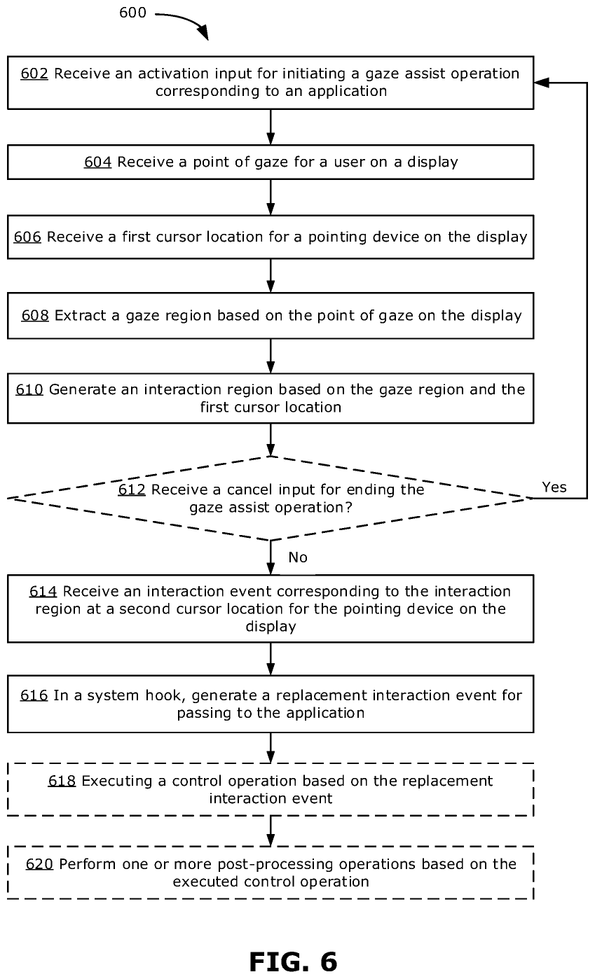

FIG. 6 is a flowchart illustrating an example method 600 for executing a gaze assist operation with a pointing device 110, in accordance with examples of the present disclosure. The method 600 may be performed by the computing system 100. For example, the processor 102 may execute computer readable instructions 300-I (which may be stored in the memory 120) to cause the computing system 100 to perform the method 600. The method 600 may be performed using a single physical machine (e.g., a workstation or server), a plurality of physical machines working together (e.g., a server cluster), or cloud-based resources (e.g., using virtual resources on a cloud computing platform).

Method 600 begins with step 602 in which a gaze assisted interaction system 300 receives an activation input 315 for initiating a gaze assist operation corresponding to an application 124. In examples, the activation input 315 may be a delimiter operation caused by the user performing an input action, to instruct the gaze assisted interaction system 300 to initiate a gaze assist operation. In examples, the input action may be generated using a device input (e.g., a mouse click, a keyboard, among others), an audio input (e.g., a voice command), a gesture input (e.g., a mid-air gesture or body movement, etc.) or a combination thereof, for example including one or more input modes or using other delimiter operation logic. In examples, the input action may be defined to require intentional action by the user, in order to avoid accidental triggering of the activation input 315. In an embodiment, for example, an input action may include a combination of a POG 240 at a first location on the display 116 and a mouse interaction at a second location on the display 116, wherein the distance between the first and second locations on the display 116 exceeds a threshold value.

In examples, prior to receiving the activation input 315, a user may be viewing a display 116 and interacting with a display contents of an application window 205, wherein the user's eyes may be fixated on a desired content on the display 116. At step 604, in response to receiving the activation input 315, the gaze assisted interaction system 300 may receive a point of gaze (POG) 240 for a user corresponding to a location of the user's gaze fixation on the display 116, from a gaze tracking system 310 of the computing system 100. In examples, the gaze tracking system 310 may capture a face image 305 corresponding to the user, and may compute a point of gaze (POG) 240 for the user on the display 116 based on the face image 305. In some embodiments, for example, the gaze assisted interaction system 300 may request the POG 240 from the gaze tracking system 310 in response to receiving the activation input 315. In other embodiments, for example, the gaze tracking system 310 may continuously capture a sequence of face images 305 for computing a respective sequence of POG 240, or may repeatedly capture a face image 305 at a predetermined frequency for computing a respective POG 240 at the predetermined frequency, for providing to the gaze assisted interaction system 300. In examples, the face image 305 may be captured by a camera 108 on the computing system 100 or may be a digital image taken by another camera on another electronic device and communicated to the computing system 100. In some embodiments, for example, image recognition techniques known in the art may be used to detect face landmarks, including eyes, in the face image 305. Further, gaze tracking techniques known in the art may be used to compute the POG 240.

At step 606, further in response to receiving the activation input 315, a first cursor location (e.g. initial cursor location 215) for a pointing device 110 on the display 116 may be received.

At step 608, a portion of the display contents may be extracted as a gaze region 325, based on the POG 240 on the display 116. In examples, the gaze region 325 may be configured as a single layered window having dimensions (w*h) that captures an image of a portion of the display contents encompassing the POG 240.

At step 610, an interaction region 345 may be generated based on the gaze region 325 and the first cursor location 215. In examples, the interaction region 345 may be an enlarged copy of the gaze region 325, for example, configured as a single layered window having dimensions (s*t) that captures a magnified image of a portion of the display contents encompassing the POG 240. Further, the interaction region 345 may be positioned on the display 116 based on the first cursor location, with the center of the interaction region 345 described by a set of coordinates (a,b) corresponding to the initial cursor location 215.

Optionally, at step 612, a cancel input may be received, for example, as a delimiter operation, for ending the gaze assist operation and removing the interaction region 345 from the display 116. In examples, a user may choose to end the gaze assist operation if the interaction region 345 has incorrectly captured the POG 240 or if the user decides to interact with a different region of the display 116, among others. In examples, following step 612, if a cancel input is received, the method may return to step 602. Otherwise, the method proceeds to step 614.

At step 614, an interaction event 350 corresponding to the interaction region 345 may be received at a second cursor location (e.g., secondary cursor location 270) on the display 116. In examples, the pointing device 110 may be used to locally position the cursor 210 over an enlarged GUI object image 281 on the interaction region 345, and an interaction event 350 (e.g., a mouse click) may be performed by the user.

At step 616, in response to receiving the interaction event 350 at the second cursor location, a replacement mapped interaction event 370 may be generated in a system hook for passing to the application 124. In examples, the system hook may intercept the interaction event 350, and may handle the interaction event 350 using its own subroutines in order to replace the coordinates associated with the interaction event 350 based on an interaction mapping 355, before passing to the application 124. In examples, the interaction mapping 355 may map a location (a′,b′) corresponding to the secondary cursor location 270 within the interaction region 345 to a corresponding replacement cursor location (x′,y′) within the gaze region 325.

Optionally, at step 618, the mapped interaction event 370 may be passed to the application 124. In passing the mapped interaction event 370 to the application 124, the application 124 may execute a control operation corresponding to a GUI object 230 associated with the mapped coordinates (x′,y′), as if the interaction event 350 had actually occurred at the mapped coordinates (x′,y′) of the mapped interaction event 370 on the display 116.

Optionally, at step 620, after the control operation has been executed, one or more post processing steps may be performed, for example, the initial cursor location 215 may be updated to reflect the coordinates of the secondary cursor location 270. In other examples, the interaction region 345 may be removed from the display and the gaze assist operation may end. In other examples, a follow-up menu may be displayed at the initial cursor location 215, for example, if further input selections are required to execute the control operation. For example, a drop down menu or a dialog may be displayed and a user may engage the pointing device 110 to make the required selections as further interaction events 350. In examples, any further interaction events 350a may be further intercepted by the system hook and further mapped interaction events 370a may be passed to the application 124.

In an example embodiment of the present disclosure, the display 116 may include a display of a laptop or a desktop computer and the pointing device 110 may include a mouse or a touchpad. In examples, the display 116 may include multiple display screens, for example, in an extended screen configuration. In another embodiment, the display 116 may include a single large display or multiple large touch screen displays, for example, where the displays are too large or elements on the display are too far away for a user to reach. In an embodiment, for example, the gaze assisted interaction system may be incorporated into an in-vehicle computing system, for example, using gaze to bring a region-of-interest on a display closer to the operator's hands.

In another example embodiment of the present disclosure, the cursor 210 may be configured for use in a text editor. In examples, a typical cursor 210 associated with a pointing device, for example, for selecting GUI objects, can be positioned at any pixel of the display. In contrast, when a cursor 210 is configured for use in a text editor, an alternate cursor (e.g., a text cursor 211) may indicate a position for text input (e.g., from a keyboard or keypad) where the text cursor is limited to a position in-between two characters in the text editor. In examples, a text cursor 211 may be repositioned by a pointing device or by arrows on a keyboard. In examples, upon the generation of an interaction region 345 corresponding to a text editor, a text cursor 211 may be automatically generated for placement at a secondary cursor location 270 associated with an interaction event 350.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
receiving an activation input for initiating a gaze assist operation corresponding to an application;
in response to receiving the activation input, receiving a point of gaze for a user on a display;
further in response to receiving the activation input, receiving a first cursor location for a pointing device on the display;
extracting a gaze region based on the point of gaze on the display;
generating an interaction region based on the gaze region and the first cursor location;
receiving an interaction event corresponding to the interaction region at a second cursor location for the pointing device on the display; and
in a system hook, generating a replacement interaction event for passing to the application, the replacement interaction event being generated in response to receiving the interaction event at the second cursor location.

2. The method of claim 1, wherein generating a replacement interaction event comprises:
receiving an interaction mapping for relating a position of the gaze region on the display to a position of the interaction region on the display;
mapping the second cursor location to a replacement cursor location based on the interaction mapping; and
generating the replacement interaction event based on the replacement cursor location.

3. The method of claim 2, further comprising:
processing the replacement interaction event to execute a command operation of the application.

4. The method of claim 1, wherein extracting the gaze region comprises:
generating an image of a portion of the content of the display based on the point of gaze.

5. The method of claim 4, wherein generating an interaction region comprises:
magnifying the image of the portion of the content of the display to generate a magnified image; and
generating the interaction region based on the magnified image and the first cursor location.

6. The method of claim 4, wherein a size of the image of the portion of the content of the display depends on a degree of accuracy of the point of gaze.

7. The method of claim 1, wherein receiving the activation input comprises:
receiving a delimiter operation input including at least one of:
a pointing device input;
a keyboard event input;
a gesture input; or
an audio input.

8. The method of claim 1, wherein receiving the activation input comprises:
receiving a delimiter operation input including:
a point of gaze at a first location on the display; and
a mouse event at a second location on the display;
wherein a distance between the first and second locations on the display exceeds a threshold value.

9. The method of claim 1, wherein obtaining a point of gaze for a user on the display comprises:
obtaining a face image for the user;
computing eye gaze information based on the face image; and
computing the point of gaze on the display based on the eye gaze information.

10. The method of claim 1, further comprising:
receiving a request to terminate the gaze assist operation.

11. A system comprising:
a pointing device;
a display;
one or more processor devices; and
one or more memories storing machine-executable instructions, which when executed by the one or more processor devices, cause the system to:
receive an activation input for initiating a gaze assist operation corresponding to an application;
in response to receiving the activation input, receive a point of gaze for a user on the display;
further in response to receiving the activation input, receive a first cursor location for the pointing device on the display;
extract a gaze region based on the point of gaze on the display;
generate an interaction region based on the gaze region and the first cursor location;
receive an interaction event corresponding to the interaction region at a second cursor location for the pointing device on the display; and
in a system hook, generate a replacement interaction event for passing to the application, the replacement interaction event being generated in response to receiving the interaction event at the second cursor location.

12. The system of claim 11, wherein the machine-executable instructions, when executed by the one or more processors cause the system to generate a replacement interaction event by:
receiving an interaction mapping for relating a position of the gaze region on the display to a position of the interaction region on the display;
mapping the second cursor location to a replacement cursor location based on the interaction mapping; and
generating the replacement interaction event based on the replacement cursor location.

13. The system of claim 12, wherein the machine-executable instructions, when executed by the one or more processors further cause the system to:
process the replacement interaction event to execute a command operation of the application.

14. The system of claim 11, wherein the machine-executable instructions, when executed by the one or more processors cause the system to extract the gaze region by:
generating an image of a portion of the content of the display based on the point of gaze.

15. The system of claim 14, wherein the machine-executable instructions, when executed by the one or more processors cause the system to generate an interaction region by:
magnifying the image of the portion of the content of the display to generate a magnified image; and
generating the interaction region based on the magnified image and the first cursor location.

16. The system of claim 14, wherein a size of the image of the portion of the content of the display depends on a degree of accuracy of the point of gaze.

17. The system of claim 11, wherein the machine-executable instructions, when executed by the one or more processors cause the system to receive the activation input by:
receiving a delimiter operation input including at least one of:
a pointing device input;
a keyboard event input;
a gesture input; or
an audio input.

18. The system of claim 11, wherein the machine-executable instructions, when executed by the one or more processors cause the system to receive the activation input by:
receiving a delimiter operation input including:
a point of gaze at a first location on the display; and
a mouse event at a second location on the display;
wherein a distance between the first and second locations on the display exceeds a threshold value.

19. The system of claim 11, wherein the machine-executable instructions, when executed by the one or more processors cause the system to obtain a point of gaze for a user on the display by:
obtaining a face image for the user;
computing eye gaze information based on the face image; and
computing the point of gaze on the display based on the eye gaze information.

20. A non-transitory computer-readable medium having machine-executable instructions stored thereon which, when executed by one or more processors of a computing system, cause the computing system to:
receive an activation input for initiating a gaze assist operation corresponding to an application;
in response to receiving the activation input, receive a point of gaze for a user on the display;
further in response to receiving the activation input, receive a first cursor location for the pointing device on the display;
extract a gaze region based on the point of gaze on the display;
generate an interaction region based on the gaze region and the first cursor location;
receive an interaction event corresponding to the interaction region at a second cursor location for the pointing device on the display; and
in a system hook, generate a replacement interaction event for passing to the application, the replacement interaction event being generated in response to receiving the interaction event at the second cursor location.
